(19) United States
(12) Patent Application Publication
(10) Pub. No.: US 2021/0050991 A1
(43) Pub. Date: Feb. 18, 2021

(54) COMPUTATION SYSTEM FOR GENERATING DIFFERENT TYPES OF CIPHER

(71) Applicant: PUFsecurity Corporation, Hsinchu County (TW)

(72) Inventors: Chun-Yuan Yu, Hsinchu County (TW); Wen-Ching Lin, Hsinchu County (TW); Chia-Cho Wu, Hsinchu County (TW)

(21) Appl. No.: 16/991,045

(22) Filed: Aug. 12, 2020

Related U.S. Application Data
(60) Provisional application No. 62/887,679, filed on Aug. 16, 2019.

(51) Int. Cl. H04L 9/06

(52) U.S. Cl. CPC H04L 9/0637; H04L 9/0631

(57) ABSTRACT

A computation system includes a first affine transform circuit, a second affine transform circuit, a computation circuit, a third affine transform circuit, and a fourth affine transform circuit. The first affine transform circuit transforms first input data of a first Galois field into first computing data of a common composite field. The second affine transform circuit transforms second input data of a second Galois field into second computing data of the common composite field. The computation circuit generates first intermediate data and second intermediate data of a common composite field by performing computations to the first computing data and the second computing data in the common composite field. The third affine transform circuit transforms the first intermediate data into first computed data of the first Galois field. The fourth affine transform circuit transforms the second intermediate data into second computed data of the second Galois field.

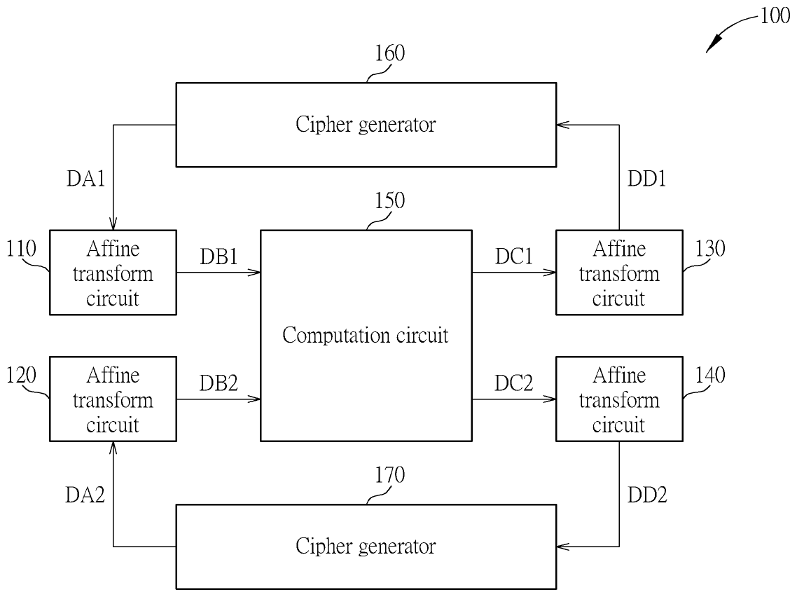

### CROSS REFERENCE TO RELATED APPLICATIONS

This non-provisional application claims priority of US provisional application No. 62/887,679, filed on Aug. 16, 2019, included herein by reference in its entirety.

### BACKGROUND OF THE INVENTION

### 1. Field of the Invention

The present invention is related to a computation system, and more particularly, to a computation system for generating different types of cipher.

### 2. Description of the Prior Art

A block cipher is usually a symmetric key cipher, and can be used to encrypt and decrypt fixed-length groups of bits, called “blocks”. Since the block cipher can encrypt two plaintexts having similar content into two ciphertexts having very different content, it is difficult for the hackers to derive the keys by observing the ciphertexts of similar plaintexts. Therefore, the block ciphers have been widely used in cryptography nowadays.

For example, Advanced Encryption Standard (AES) cipher, SM4 cipher, and Camellia cipher are some of the popular and standardized block ciphers. However, since the algorithms adopted by different types of block ciphers are usually performed in different Galois fields, the hardware used for generating different types of block ciphers are usually specifically designed, thereby making it complicated to design a unified system for different types of block ciphers.

### SUMMARY OF THE INVENTION

One embodiment of the present invention discloses a computation system. The computation system includes a first affine transform circuit, a second affine transform circuit, a computation circuit, a third affine transform circuit, and a fourth affine transform circuit.

The first affine transform circuit transforms first input data of a first Galois field into first computing data of a common composite field, and the second affine transform circuit transforms second input data of a second Galois field into second computing data of the common composite field. The computation circuit is coupled to the first affine transform circuit and the second affine transform circuit. The computation circuit generates first intermediate data of the common composite field by performing a computation to the first computing data in the common composite field, and generates second intermediate data of the common composite field by performing the computation to the second computing data of the common composite field.

The third affine transform circuit is coupled to the computation circuit, and transforms the first intermediate data into first computed data of the first Galois field. The fourth affine transform circuit is coupled to the computation circuit, and transforms the second intermediate data into second computed data of the second Galois field.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The figure shows a computation system according to one embodiment of the present invention.

### DETAILED DESCRIPTION

The figure shows a computation system 100 according to one embodiment of the present invention. The computation system 100 includes affine transform circuits 110, 120, 130, and 140, and a computation circuit 150. The computation circuit 150 can be coupled to the affine transform circuits 110, 120, 130, and 140. In some embodiments, the computation system 100 can be used to generate different types of ciphers, such as Advanced Encryption Standard (AES) cipher, SM4 cipher, and Camellia cipher.

In some embodiments, the algorithms for generating the Advanced Encryption Standard (AES) cipher, the SM4 cipher, and the Camellia cipher may require the same computation. However, since different types of ciphers may be generated indifferent Galois fields, the affine transform circuits 110 and 120 can be used to transform the data from the original Galois fields to the common composite field adopted by the computation circuit 150. In this case, the computation circuit 150 will be able to perform the common computation for different types of ciphers, and the affine transform circuits 130 and 140 can transform the computing result generated by the computation circuit 150 back to the corresponding Galois fields. Since the computation system 100 can use the computation circuit 150 to perform computations for different types of ciphers, the hardware efficiency can be improved and the area required by the computation system 100 can be reduced.

For example, in the figure, the computation system 100 can further include cipher generators 160 and 170. The cipher generator 160 can be used to generate the AES cipher, and the cipher generator 170 can be used to generate the SM4 cipher. In this case, the computation circuit 150 can be used to perform an inverse operation required by the Advanced Encryption Standard (AES) cipher and the SM4 cipher.

In the figure, the cipher generator 160 can transmit the data to be inversed to the affine transform circuit 110 as the input data DA1, and the affine transform circuit 110 will transform the input data DA1 of the first Galois field into the computing data DB1 of the common composite field adopted by the computation circuit 150 so that the computation circuit 150 can perform the inverse operation correctly.

In some embodiments, the irreducible polynomials of the common composite field adopted by the computation circuit 150 are shown below.

GF(2²)->GF(2): x²+x+1 (1)

GF((2²)²)->GF(2²): x²+x+φ (2)

GF(((2²)²)²)->GF((2²)²): x²+x+λ (3)

Also, in irreducible polynomial (2), φ can be {10}₂, and in irreducible polynomial (3), λ can be {1100}₄. In addition, the irreducible polynomial of the first Galois field defined by AES is shown below.

GF(2⁸): x⁸+x⁴+x³+x+1 (4)

That is, the input data DA1 can be represented by 8 bits of data. In this case, the isomorphism matrix T1 used by the affine transform circuit 110 can be shown by formula (5), and the transform between the input data DA1 and the computing data DB1 can be performed with formula (6).

$$\begin{matrix}T 1 = \{ \begin{matrix}\begin{matrix}\begin{matrix}\begin{matrix}\begin{matrix}\begin{matrix}\begin{matrix}1 \; 0 \; 1 \; 0 \; 0 \; 0 \; 0 \; 0 \\ 1 \; 1 \; 0 \; 1 \; 1 \; 1 \; 1 \; 0\end{matrix} \\ 1 \; 0 \; 1 \; 0 \; 1 \; 1 \; 0 \; 0\end{matrix} \\ 1 \; 0 \; 1 \; 0 \; 1 \; 1 \; 1 \; 0\end{matrix} \\ 1 \; 1 \; 0 \; 0 \; 0 \; 1 \; 1 \; 0\end{matrix} \\ 1 \; 0 \; 0 \; 1 \; 1 \; 1 \; 1 \; 0\end{matrix} \\ 0 \; 1 \; 0 \; 1 \; 0 \; 0 \; 1 \; 0\end{matrix} \\ 0 \; 1 \; 0 \; 0 \; 0 \; 0 \; 1 \; 1\end{matrix} \} & ( 5 ) \\ DB 1 = T 1 \cdot DA 1 = \{ \begin{matrix}\begin{matrix}\begin{matrix}\begin{matrix}\begin{matrix}\begin{matrix}\begin{matrix}1 \; 0 \; 1 \; 0 \; 0 \; 0 \; 0 \; 0 \\ 1 \; 1 \; 0 \; 1 \; 1 \; 1 \; 1 \; 0\end{matrix} \\ 1 \; 0 \; 1 \; 0 \; 1 \; 1 \; 0 \; 0\end{matrix} \\ 1 \; 0 \; 1 \; 0 \; 1 \; 1 \; 1 \; 0\end{matrix} \\ 1 \; 1 \; 0 \; 0 \; 0 \; 1 \; 1 \; 0\end{matrix} \\ 1 \; 0 \; 0 \; 1 \; 1 \; 1 \; 1 \; 0\end{matrix} \\ 0 \; 1 \; 0 \; 1 \; 0 \; 0 \; 1 \; 0\end{matrix} \\ 0 \; 1 \; 0 \; 0 \; 0 \; 0 \; 1 \; 1\end{matrix} \} \{ \begin{matrix}{x}_{0} \\ {x}_{1} \\ {x}_{2} \\ {x}_{3} \\ {x}_{4} \\ {x}_{5} \\ {x}_{6} \\ {x}_{7}\end{matrix} \} & ( 6 )\end{matrix}$$

In formula (6), the 8 bits x₀ to x₇ of the input data DA1 are represented as a vector, and the transform can be performed by the matrix multiplication. After the transformation, the computation circuit 150 will perform the inverse operation to the computing data DB1 of the common composite field and generate the intermediate data DC1 of the common composite filed.

Afterward, in the figure, the affine transform circuit 130 will transform the intermediate data DC1 into the computed data DD1 of the first Galois field so the cipher generator 160 can complete the required computations with the computed data DD1 for generating the AES cipher.

In some embodiments, the isomorphism matrix T2 shown in formula (7) can be adopted by the affine transform circuit 130 to transform the intermediate data DC1 of the common composite field into the computed data DD1 of the first Galois field.

$$T 2 = \{ \begin{matrix}1 \; 1 \; 1 \; 0 \; 0 \; 0 \; 1 \; 0 \\ 0 \; 1 \; 0 \; 0 \; 0 \; 1 \; 0 \; 0 \\ 0 \; 1 \; 1 \; 0 \; 0 \; 0 \; 1 \; 0 \\ 0 \; 1 \; 1 \; 1 \; 0 \; 1 \; 1 \; 0 \\ 0 \; 0 \; 1 \; 1 \; 1 \; 1 \; 1 \; 0 \\ 1 \; 0 \; 0 \; 1 \; 1 \; 1 \; 1 \; 0 \\ 0 \; 0 \; 1 \; 1 \; 0 \; 0 \; 0 \; 0 \\ 0 \; 1 \; 1 \; 1 \; 0 \; 1 \; 0 \; 1\end{matrix} \} \qquad ( 7 )$$

In some embodiments, when generating the SM4 cipher, the cipher generator 170 can transmit the data to be inversed to the affine transform circuit 120 as the input data DA2, and the affine transform circuit 120 will transform the input data DA2 of a second Galois field into the computing data DB2 of the common composite field adopted by the computation circuit 150 so that the computation circuit 150 can perform the inverse operation correctly.

In some embodiments, the irreducible polynomial of the second Galois field defined by SM4 is shown below.

GF(2⁸): x⁸+x⁷+x⁶+x⁵+x⁴+x²+1 (8)

That is, the input data DA2 can be represented by 8 bits of data. With the composite field defined by the irreducible polynomials (1) to (3) aforementioned, the isomorphism matrix T3 can be adopted by the affine transform circuit 120 as shown by formula (9).

$$T 3 = \{ \begin{matrix}0 \; 1 \; 0 \; 1 \; 1 \; 1 \; 1 \; 0 \\ 1 \; 0 \; 1 \; 0 \; 1 \; 1 \; 0 \; 0 \\ 1 \; 1 \; 0 \; 1 \; 0 \; 0 \; 0 \; 0 \\ 0 \; 0 \; 1 \; 0 \; 1 \; 1 \; 0 \; 0 \\ 0 \; 0 \; 1 \; 0 \; 0 \; 0 \; 0 \; 0 \\ 0 \; 1 \; 0 \; 0 \; 1 \; 0 \; 1 \; 0 \\ 1 \; 0 \; 1 \; 0 \; 0 \; 1 \; 1 \; 0 \\ 0 \; 0 \; 0 \; 1 \; 0 \; 0 \; 0 \; 1\end{matrix} \} \qquad ( 9 )$$

In this case, the affine transform circuit 120 can perform a matrix multiplication to the isomorphism matrix T3 and the input data DA2 to generate the computing data DB2. Since the computing data DB2 is now in the common composite field, the computation circuit 150 can perform the inverse operation to the computing data DB2 and generate the intermediate data DC2 in the common composite filed.

After the intermediate data DC2 is generated, the affine transform circuit 140 can further transform the intermediate data DC2 into the computed data DD2 of the second Galois field, so the cipher generator 170 can complete the required computations with the computed data DD2 for generating the SM4 cipher.

In some embodiments, the isomorphism matrix T4 shown in formula (10) can be adopted by the affine transform circuit 140 to transform the intermediate data DC2 of the common composite field into the computed data DD2 of the second Galois field.

$$T 4 = \{ \begin{matrix}0 \; 1 \; 0 \; 1 \; 0 \; 0 \; 0 \; 0 \\ 0 \; 1 \; 0 \; 0 \; 0 \; 1 \; 1 \; 0 \\ 0 \; 0 \; 0 \; 0 \; 1 \; 0 \; 0 \; 0 \\ 0 \; 0 \; 1 \; 1 \; 0 \; 1 \; 1 \; 0 \\ 1 \; 0 \; 1 \; 0 \; 1 \; 0 \; 1 \; 0 \\ 1 \; 0 \; 1 \; 1 \; 0 \; 0 \; 1 \; 0 \\ 1 \; 1 \; 1 \; 0 \; 1 \; 0 \; 0 \; 0 \\ 0 \; 0 \; 1 \; 1 \; 0 \; 1 \; 1 \; 1\end{matrix} \} \qquad ( 10 )$$

Consequently, by transforming data of different Galois field into computing data of the same composite field, the same computations required by different ciphers can be performed by the same computation circuit.

Furthermore, in the figure, the cipher generator 160 can be used to generate the AES cipher and the cipher generator 170 can be used to generate the SM4 cipher. However, in some other embodiments, the cipher generator 160 or 170 can be replaced by another cipher generator for generating another type of cipher, such as the Camellia cipher. In this case, since the generation of Camellia cipher also requires the inverse operation, the computation circuit 150 can still be used to perform the inverse operation if the affine transform circuits 110 and 130 are able to transform the data between the corresponding Galois field and the composite field adopted by the computation circuit 150.

In addition, in some embodiments, the computation system 100 can further include more cipher generators to generate other types of ciphers, such as the Camellia cipher. In this case, by transforming data between corresponding Galois fields and the composite field adopted by the computation circuit 150 with the affine transform circuits, the common operations required by the different ciphers can still be performed by the same computation circuit 150. Therefore, hardware efficiency can be improved.

Also, in some embodiments, the complexity of the computations performed by the computation circuit 150 is related to the Galois field used; therefore, by selecting the composite field properly for the computation circuit 150, the computation can also be simplified, thereby improving the computation efficiency and/or saving the computation power.

In summary, the computation system provided by the embodiments of the present invention can use the affine transform circuits to transform the data between different Galois fields and the common composite field so the common computations required by different types of ciphers can be performed by the same computation circuit. Consequently, the computation system can be simplified, thereby improving the computation efficiency and/or saving the computation power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computation system comprising:
a first affine transform circuit configured to transform first input data of a first Galois field into first computing data of a common composite field;
a second affine transform circuit configured to transform second input data of a second Galois field into second computing data of the common composite field;
a computation circuit coupled to the first affine transform circuit and the second affine transform circuit, and configured to generate first intermediate data of the common composite field by performing a computation to the first computing data of the common composite field, and generate second intermediate data of the common composite field by performing the computation to the second computing data of the common composite field;
a third affine transform circuit coupled to the computation circuit, and configured to transform the first intermediate data into first computed data of the first Galois field; and
a fourth affine transform circuit coupled to the computation circuit, and configured to transform the second intermediate data into second computed data of the second Galois field.

2. The computation system of claim 1, wherein the computation system is configured to generate two of Advanced Encryption Standard (AES) cipher, SM4 cipher, and Camellia cipher according to the first computed data and the second computed data.

3. The computation system of claim 2, wherein the computation performed by the computation circuit is an inverse operation required by the Advanced Encryption Standard (AES) cipher, the SM4 cipher, and the Camellia cipher.

4. The computation system of claim 1, wherein irreducible polynomials of the common composite field are:
GF(2²)->GF(2): x²+x+1;
GF((2²)²)->GF(2²): x²+x+φ;
GF(((2²)²)²)->GF((2²)²): x²+x+λ;
wherein φ is {10}₂ and λ is {1100}₄.

5. The computation system of claim 4, wherein the first Galois field is defined according to Advanced Encryption Standard, and an irreducible polynomial of the first Galois field is GF(2⁸): x⁸+x⁴+x³+x+1.

6. The computation system of claim 5, wherein the first affine transform circuit transforms the first input data of the first Galois field into the first computing data of the common composite
$$\{ \begin{matrix}1 \; 0 \; 1 \; 0 \; 0 \; 0 \; 0 \; 0 \\ 1 \; 1 \; 0 \; 1 \; 1 \; 1 \; 1 \; 0 \\ 1 \; 0 \; 1 \; 0 \; 1 \; 1 \; 0 \; 0 \\ 1 \; 0 \; 1 \; 0 \; 1 \; 1 \; 1 \; 0 \\ 1 \; 1 \; 0 \; 0 \; 0 \; 1 \; 1 \; 0 \\ 1 \; 0 \; 0 \; 1 \; 1 \; 1 \; 1 \; 0 \\ 0 \; 1 \; 0 \; 1 \; 0 \; 0 \; 1 \; 0 \\ 0 \; 1 \; 0 \; 0 \; 0 \; 0 \; 1 \; 1\end{matrix} \} .$$
field according to an isomorphism matrix

7. The computation system of claim 5, wherein the third affine transform circuit transforms the first intermediate data into the first computed data of the first Galois field according to an isomorphism matrix
$$\{ \begin{matrix}1 \; 1 \; 1 \; 0 \; 0 \; 0 \; 1 \; 0 \\ 0 \; 1 \; 0 \; 0 \; 0 \; 1 \; 0 \; 0 \\ 0 \; 1 \; 1 \; 0 \; 0 \; 0 \; 1 \; 0 \\ 0 \; 1 \; 1 \; 1 \; 0 \; 1 \; 1 \; 0 \\ 0 \; 0 \; 1 \; 1 \; 1 \; 1 \; 1 \; 0 \\ 1 \; 0 \; 0 \; 1 \; 1 \; 1 \; 1 \; 0 \\ 0 \; 0 \; 1 \; 1 \; 0 \; 0 \; 0 \; 0 \\ 0 \; 1 \; 1 \; 1 \; 0 \; 1 \; 0 \; 1\end{matrix} \} .$$

8. The computation system of claim 4, wherein the second Galois field is defined according to SM4, and an irreducible polynomial of the second Galois field is GF(2⁸): x⁸+x⁷+x⁶+x⁵+x⁴+x²+1.

9. The computation system of claim 8, wherein the second affine transform circuit transforms the second input data of the second Galois field into the second computing data of the common composite field according to an isomorphism matrix
$$\{ \begin{matrix}0 \; 1 \; 0 \; 1 \; 1 \; 1 \; 1 \; 0 \\ 1 \; 0 \; 1 \; 0 \; 1 \; 1 \; 0 \; 0 \\ 1 \; 1 \; 0 \; 1 \; 0 \; 0 \; 0 \; 0 \\ 0 \; 0 \; 1 \; 0 \; 1 \; 1 \; 0 \; 0 \\ 0 \; 0 \; 1 \; 0 \; 0 \; 0 \; 0 \; 0 \\ 0 \; 1 \; 0 \; 0 \; 1 \; 0 \; 1 \; 0 \\ 1 \; 0 \; 1 \; 0 \; 0 \; 1 \; 1 \; 0 \\ 0 \; 0 \; 0 \; 1 \; 0 \; 0 \; 0 \; 1\end{matrix} \} .$$

10. The computation system of claim 8, wherein the fourth affine transform circuit transforms the second intermediate data into the second computed data of the second Galois field according to an isomorphism matrix
$$\{ \begin{matrix}0 \; 1 \; 0 \; 1 \; 0 \; 0 \; 0 \; 0 \\ 0 \; 1 \; 0 \; 0 \; 0 \; 1 \; 1 \; 0 \\ 0 \; 0 \; 0 \; 0 \; 1 \; 0 \; 0 \; 0 \\ 0 \; 0 \; 1 \; 1 \; 0 \; 1 \; 1 \; 0 \\ 1 \; 0 \; 1 \; 0 \; 1 \; 0 \; 1 \; 0 \\ 1 \; 0 \; 1 \; 1 \; 0 \; 0 \; 1 \; 0 \\ 1 \; 1 \; 1 \; 0 \; 1 \; 0 \; 0 \; 0 \\ 0 \; 0 \; 1 \; 1 \; 0 \; 1 \; 1 \; 1\end{matrix} \} .$$
